(19) United States
(12) Patent Application Publication
(10) Pub. No.: US 2026/0167326 A1
(43) Pub. Date: Jun. 18, 2026

(54) TAIL-INTEGRATED BOUNDARY-LAYER INGESTING PROPULSION

(71) Applicants: MITSUBISHI HEAVY INDUSTRIES, LTD., Tokyo (JP); MASSACHUSETTS INSTITUTE OF TECHNOLOGY, Cambridge, MA (US)

(72) Inventors: Kazuhiro IMAI, Tokyo (JP); Yuki MORISAKI, Tokyo (JP); Satoshi YAMASHITA, Tokyo (JP); Yuji KOIKE, Tokyo (JP); Zoltan SPAKOVSZKY, Watertown, MA (US); Zhibo CHEN, Cambridge, MA (US); Marshall GALBRAITH, Boston, MA (US); Edward GREITZER, Wayland, MA (US); Jayant SABNIS, Glastonbury, CT (US)

(73) Assignees: MITSUBISHI HEAVY INDUSTRIES, LTD., Tokyo (JP); MASSACHUSETTS INSTITUTE OF TECHNOLOGY, Cambridge, MA (US)

(21) Appl. No.: 19/126,554

(22) PCT Filed: Aug. 28, 2023
(86) PCT No.: PCT/JP2023/031034

§ 371 Date: May 1, 2025

Related U.S. Application Data
(60) Provisional application No. 63/422,716, filed on Nov. 4, 2022.

(51) Int. Cl. B64C 21/01; B64D 27/20; B64D 29/04

(52) U.S. Cl. CPC B64C 21/01; B64D 27/20; B64D 29/04

(57) ABSTRACT

Propulsion systems, methods and aircraft related to boundary layer ingestion are described. In some embodiments, an aircraft may include a fuselage with a plurality of boundary layer ingesting propulsors may be disposed on and distributed around at least a portion of a 5 perimeter of the fuselage. An annular exit nozzle may be fluidly coupled to a plurality of propulsor outlets of the plurality of propulsors such that an outflow from the plurality of propulsors flows through the annular exit nozzle during operation of the aircraft. In other embodiments, a boundary layer ingesting propulsor may be disposed on the fuselage where a portion of the fuselage upstream from the inlet may be configured to provide a desired Mach 10 number for fluid located within a predetermined distance of the propulsor inlet during cruise of the aircraft.

### TECHNICAL FIELD

The present disclosure relates generally to boundary layer ingesting propulsion and in particular to tail mounted applications for aircraft.

### BACKGROUND ART

Boundary layer ingestion (BLI), is a method to propel an aircraft where the slower moving air in the boundary layer surrounding an aircraft is intentionally directed into the inlet of a propulsion system to propel the aircraft. Historical air craft design practice has been to place propulsor intakes outside or ahead of boundary layer development for the purpose of providing substantially steady and uniform flow to the propulsors.

### SUMMARY OF INVENTION

According to one aspect, an aircraft comprises a fuselage and a plurality of propulsors disposed on and distributed around at least a portion of a perimeter of the fuselage. The plurality of propulsors are configured to ingest at least a portion of a boundary layer from the fuselage during operation of the aircraft. The aircraft additionally comprises an annular exit nozzle fluidly coupled to a plurality of propulsor outlets of the plurality of propulsors, wherein an outflow from the plurality of propulsors flows through the annular exit nozzle during operation of the aircraft.

According to another aspect, an aircraft comprises a fuselage and a propulsor disposed on the fuselage. The propulsor includes a propulsor inlet configured to ingest at least a portion of a boundary layer from the fuselage. A portion of the fuselage upstream from the inlet is configured to provide an average Mach number of at least 0.4 in fluid two inlet diameters upstream from and adjacent to the propulsor inlet extension highlight during cruise of the aircraft.

According to some aspects, a method for operating a boundary layer ingesting aircraft propulsion system is provided. The method comprises ingesting at least a portion of a boundary layer attached to a fuselage of an aircraft into a plurality of propulsors and flowing an outflow from the plurality of propulsors through an annular exit nozzle.

It should be appreciated that the foregoing concepts, and additional concepts discussed below, may be arranged in any suitable combination, as the present dis closure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a side view of an aircraft with one embodiment of a BLI propulsion system;

FIG. 1B is a rear perspective view of one embodiment of a BLI propulsion system shown without the horizontal and vertical stabilizers;

FIG. 1C is a front perspective view of the embodiment of a BLI propulsion system shown without the horizontal and vertical stabilizers;

FIG. 2A is a rear facing view of aircraft silhouette with a BLI propulsion system according to one embodiment.

FIG. 2B is a rear facing view of a baseline aircraft silhouette.

FIG. 3 is a side view of one embodiment of a BLI propulsion system shown without the horizontal and vertical stabilizers;

FIG. 4 is a cross sectional view of the embodiment of a BLI propulsion system show in in FIG. 3;

FIG. 5 is a side view of a representative ellipsoidal fuselage showing boundary layer growth thereon according to one embodiment;

FIG. 6 is a section through one BLI propulsor according to one embodiment;

FIG. 7A is a section through one embodiment with an S-shaped fuselage taper according to one embodiment;

FIG. 7B is a section though one embodiment with an arc shaped fuselage taper according to one embodiment;

FIG. 8 is a plot showing the relation between inlet area and ingested mechanical power for the fuselage embodiments of FIGS. 7A and 7B;

FIG. 9A is a plot of Mach number versus upstream position for one embodiment of a BLI propulsor;

FIG. 9B is a plot of Mach number versus position for one embodiment of a BLI propulsor; and

FIG. 10 shows contours of the axial Mach number at propulsor centerline and the boundary layer edge streamline.

### DESCRIPTION OF EMBODIMENTS

Aircraft propulsors including fans and gas turbines have historically been located away from boundary layers that develop around the surface of a moving air craft. Boundary layer ingestion (BLI) represents a propulsor configuration wherein the boundary layer is drawn into the propulsor for the purpose of enhancing the fuel economy of the aircraft. Without wishing to be bound by theory, BLI accelerates the slower moving boundary layer flow through the propulsor thereby improving the propulsive efficiency as, for the same drag, less mechanical work may be used when the lower momentum fluid ingested is accelerated to near free-stream velocity than for a non-BLI propulsion system ingesting fluid from free stream conditions and accelerating the fluid to an excess jet velocity. The benefit may be manifested in propulsor power savings as less mechanical work is wasted to balance power.

The Inventors have recognized that BLI propulsion offers the potential for increased aircraft efficiency, reduced fuel burn, longer range, and/or reduced propulsor power consumption. For example, while BLI does not eliminate the effect of the boundary layer, it does allow for power savings compared to a conventional (non BLI) propulsion system as described above. BLI may additionally be combined with electric propulsors. The inventors have recognized improvements to BLI propulsion and methods of employing BLI propulsion for increased efficiency, including to increase efficiency of transport aircraft. However, the Inventors have also recognized that unless appropriately controlled, the use of BLI propulsion may result in flow separation which may increase the fluid drag acting on a body moving through a fluid. In some instances, flow separation may be extreme enough to cause the flow to locally reverse direction within the separated region. While flow separation may occur at any location along the length of an aircraft depending on design, specific areas where flow separation may be of concern may include, but are not limited to, rear-facing tail structures and the back sides of pylons, nacelles or other protrusions associated with a BLI propulsion system that may be susceptible to flow separation during operation if not properly designed and operated.

In view of the above, the Inventors have recognized the benefits associated with a BLI propulsion system designed to avoid, or at least reduce, the occurrence of flow separation during operation. This may help to avoid increased drag on an aircraft and help ensure proper ingestion of the boundary layer in the BLI propulsion system. For this reason it may be desirable in some embodiments to design the aircraft fuselage and BLI propulsion system to maintain boundary layer attachment both upstream (i.e., forward) and downstream (i.e., rearward) from the BLI propulsors of an aircraft.

Based on the forgoing, the inventors have recognized and appreciated ways to incorporate BLI propulsors into an aircraft design. In some embodiments, a plurality of BLI propulsors may be disposed on, or otherwise attached to, a fuselage of the aircraft. The BLI propulsors may be disposed at a desired location a long a length of the fuselage that includes an attached boundary layer during operation at the designed cruise conditions of the aircraft. The propulsors may be distributed around a perimeter of the fuselage such that the propulsors may ingest at least a portion, and in some instances a majority, of the boundary layer upstream from and adjacent to the BLI propulsors. While any appropriate number of propulsors may be used, the number of propulsors may be limited by the circumference, or other appropriate dimension, of the fuselage at the point of attachment of the propulsors and the size, such as the diameter, of the propulsors. In some instances, the propulsors may be close-packed around the fuselage, though instances in which the propulsors are spaced apart from one another are also contemplated. Additionally, the spacing of the propulsors may be selected to be axisymmetric around the centerline of the fuselage, asymmetric, or any other pattern.

The plurality of propulsors distributed around at least a portion of the fuselage may include a separate corresponding propulsor outlet fluidly coupled to each propulsor. Without further control, flow around and between these propulsors and propulsor outlets may create the potential for flow separation with a resulting reduction in aircraft efficiency. Therefore, the inventors have recognized and appreciated improvements associated with the use of a single nozzle that may create a single combined outflow from the BLI propulsion system which may exhibit reduced flow separation. Specifically, in some embodiments, an annular exit nozzle may be fluidly coupled to the plurality of propulsor outlets of the plurality of propulsors. Accordingly, an outflow from the plurality of propulsors may flow out from the individual propulsor outlets into and through the annular exit nozzle during operation of the aircraft. This combined outflow from the annular exit nozzle may exhibit reduced flow separation as compared to a system without the annular exit nozzle.

In addition to preventing flow separation, in some embodiments, it may be desirable to provide fluid flows within a desired Mach number range upstream from the inlets of the propulsors of a BLI propulsion system during operation at cruise. This may beneficially pre-compress the air to be ingested by the propulsors to improve the performance of the overall system. In some embodiments a portion of the fuselage upstream from the inlet of one or more propulsors of the aircraft may be configured to provide an average Mach number of at least 0. 4 in fluid two inlet diameters upstream from and adjacent to a propulsor inlet extension highlight during cruise of the aircraft. As used herein, a propulsor inlet extension highlight may refer to a most upstream portion of the propulsor inlet as taken relative to a direction of travel of the aircraft during normal operation.

In some embodiments the BLI propulsors may be disposed on a rear portion of the fuselage of an aircraft. In some embodiments, the fuselage is a substantially cylindrical structure. The fuselage diameter may taper down at the rear of the fuselage (rear being interpreted as away from forward moving direction of an aircraft in flight). The tapered portion may be called the tail. “Tail” should not to be taken to mean any airfoil structure or stabilizer of any orientation although these may be attached to the tail portion of the fuselage. The tail may be axisymmetric or asymmetric. For instance, in an asymmetric embodiment, the top surface of the tail may extend along a horizontal line formed by the top surface of the substantially cylindrical portion of the fuselage while the lower side of the tail tapers upward to meet the top surface at the end of the fuselage. Similar asymmetric configurations may be observed in many conventional mid-range aircraft such as a Boeing 737. However, it should be understood that the currently disclosed propulsors and other structures may be associated with any other appropriate portion of an aircraft where a boundary layer is present during normal operation of the aircraft.

Depending on the desired operating parameters, a BLI propulsion system may be configured to ingest any desired portion of a boundary layer of an aircraft adjacent to the BLI propulsion system during cruise and/or other appropriate operating conditions. In some embodiments, a BLI propulsion system may ingest at least 50%, 60%, 70%, 80%, and/or any other appropriate percentage of the boundary layer. For example, in some embodiments, a BLI propulsion system may be configured to ingest between or equal to 50% and 80% of the boundary layer, including for example about 70% of the boundary layer. However, embodiments in which substantially all of the boundary layer is ingested and/or other percentages both greater and lower than those noted above are realized are also contemplated as the disclosure is not so limited.

In some embodiments, the BLI propulsion systems described herein may be applied to a cylinder and wing type of aircraft such as a typical present-day medium range commercial airliner. However, it should be understood that other embodiments may be applied to other types of aircraft in any appropriate mounting configuration as this disclosure is not limited to any particular type of aircraft.

The inventors have recognized and appreciated that aspects described in this disclosure may be applied to transportation aircraft. Typical transportation aircraft have a wing and tube construction. One example would be a 737-800 aircraft. Transportation aircraft typically cruise between 20,000-43,000 ft at a Mach n umber between 0.7-0.85, although some may operate higher or lower and at speeds that are slower or slightly faster. Some small transports such as the Gulfstream G550 have higher service ceilings of, for instance, 51,000 ft. Subsonic military aircraft with shapes similar to transport aircraft such as a B-52 may have similarly high ceilings. Thus, in some embodiments, the various aircraft described herein including BLI propulsion systems may have operating parameters such as boundary layer ingestion percentage, efficiency, and other parameters that a re evaluated during cruise conditions which may correspond to operation of the aircraft at an altitude between 20,000-51,000 ft and a Mach number between 0.7-0.85. However, it should be understood that the specific cruise conditions for a given aircraft may vary based on design and desired mission parameters.

It should be understood that the process of designing an aircraft may be iterative and that many parameters are interrelated to other parameters. For instance the boundary layer thickness at the propulsor inlet may be determined by the speed and altitude of the aircraft, while speed and altitude are themselves influenced by the propulsion system used on the aircraft. Similarly, changes in aircraft geometry may affect flow that may trigger further design activity elsewhere on the aircraft. Thus, the optimization of a BLI propulsion system is a non-tri vial undertaking that may be done iteratively to arrive at a desired design.

Any appropriate type of propulsion system, including a propulsor that converts mechanical power to propulsive power or a motor that converts chemical power into mechanical power, may be used with the various embodiments described herein. The propulsion system accelerates airflow to create a reaction force to propel the aircraft. Gas turbine aero-engines are a common example. Propulsors may be propellers or fans and motors may be heat engines (i.e. a gas turbine engine or an internal combustion engine) or electrical machines (i.e. an electric motor). The electric motor driving a fan may receive electric power from a generator, batteries, fuel cell or other appropriate power source on board the aircraft. Accordingly, it should be understood that the current disclosure is not limited to any particular type of propulsor and motor and their arrangement. For example, multiple propulsors could be driven by a single motor or a subset of motors connected via gear and shaft assemblies.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

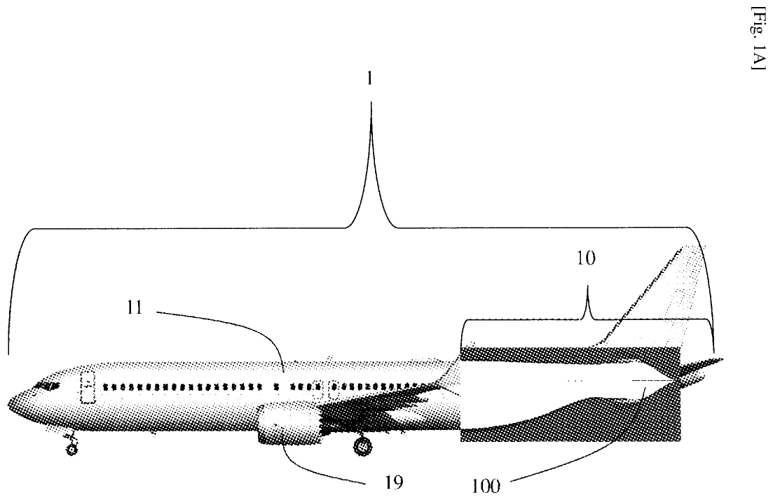

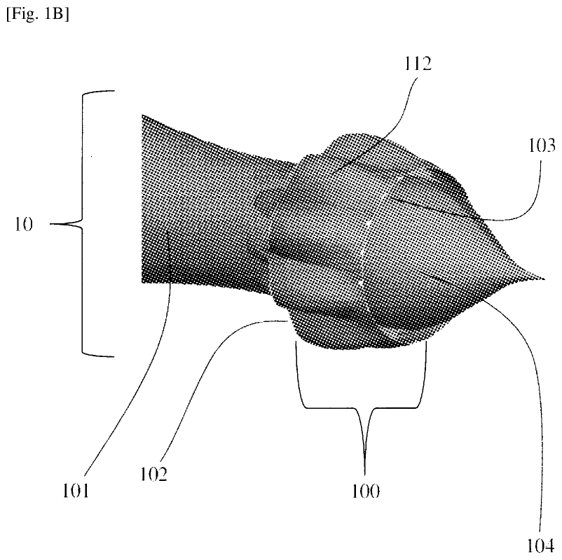

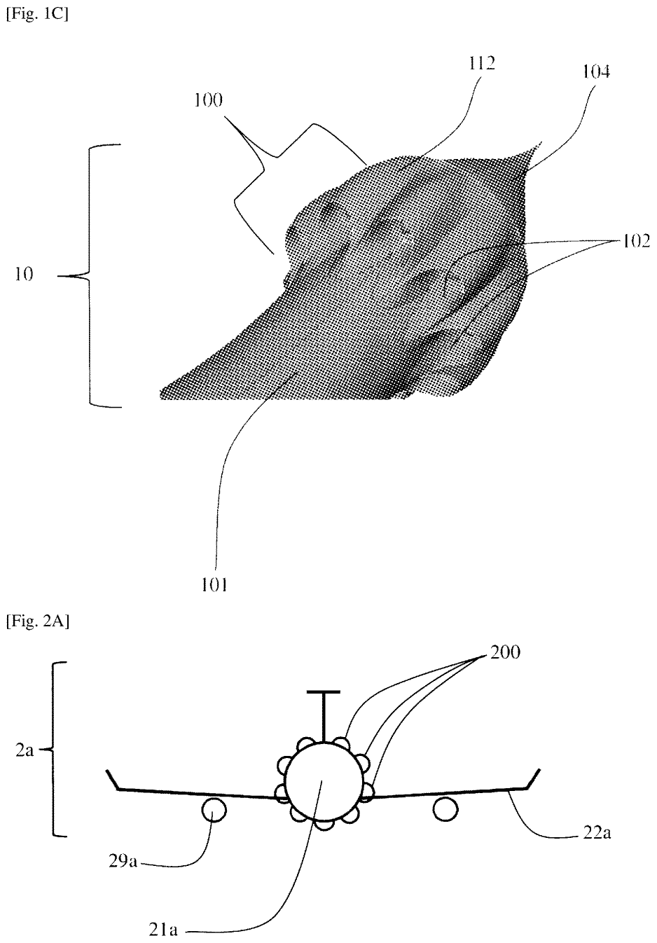

FIG. 1A shows, according to some embodiments, a tail mounted BLI propulsion system superimposed over a baseline aircraft onto which the BLI propulsion system may be incorporated. Specifically, the aircraft 1 has a rear portion 10, that may be a tail portion in some embodiments, of fuselage 11. A BLI propulsion system 100 may be disposed on, or otherwise integrated with the rear portion of the fuselage in some embodiments. A conventional underwing propulsion system 19 attached to a corresponding wing of the aircraft is shown in the figure. The underwing propulsion system 19 is not boundary layer ingesting.

FIGS. 1B and 1C show perspective views of one embodiment of a BLI propulsion system disposed along a length of the fuselage 101. In the depicted embodiment, the BLI propulsion system is mounted to a rear or tail portion 10 of the fuselage 101. For example, a plurality of BLI propulsors may be disposed on and distributed around at least a portion of a perimeter of the fuselage. In the illustrated embodiment, nine individual propulsors are used but it should be understood that more or fewer propulsors may be used. The propulsor inlets 102 are located at the upstream end portion of the separate propulsors. The propulsor inlets may include an upstream extension which may include a smooth transition between the fuselage and the inlet to help prevent flow separation. A nacelle 112 may cover the plurality of propulsors 100 such that the nacelle form s at least a portion, and in some embodiments the entire outer surface of the different propulsors. Additionally, in some embodiments, a rear portion of the nacelle 112, or other appropriate structure, may form an annular nozzle 103 that is in fluid communication with and provides a common outlet to the plurality of propulsors. The individual outlets of the propulsors discharge into the annular region of nozzle 103 such that the common annular nozzle 103 is fluidly coupled to all of the outlets of the individual propulsors. Thus, a combined flow from the separate propulsors may exit through the annular nozzle 103. In embodiments where the disclosed BLI propulsion systems are mounted on a tail portion of an aircraft, the aircraft may include a tail cone 104 corresponding to a portion of the fuselage downstream from the BLI propulsion system. In some embodiments, the inner diameter, or other profile, of the annular nozzle 103 may be formed by the tail cone 104 or other portion of the fuselage. Additionally, to help further prevent flow separation downstream from the tail cone may be tapered along its length such that a characteristic transverse dimension (e.g., a diameter) of the tail cone may decrease in a downstream or rearward oriented direction of the aircraft.

In the above embodiment, there are specific challenges in nozzle design for tail-integrated propulsors. A circular nozzle does not allow low-loss integration of BLI propulsors 100 on the tail, because the area between the lower portion of a nozzle surface and the tail exhibits flow separation beneath the nozzle. The nozzle exit area is smaller than the propulsor inlet area, so the flow passage be tween adjacent nacelles diverges as it approaches to the nozzle exit. In consequence, the flow between nacelles may experience excessive diffusion and separate from the nacelle surface as it moves towards the nozzle exit. The annular exit nozzle 103 is configured to mitigate this issue.

Within the common annular exit nozzle 103, upstream walls may isolate the individual propulsors. The plurality of propulsors may be covered by a nacelle 112, the rear portion of which may form the outer portion of the annular exit nozzle. Flow separation may be prevented by minimizing the flow expansion or flow diffusion in the space between and behind the individual propulsors. This may be quantified by the ratio of the flow area between propulsors at the inlet and at the outlet ends of the propulsor nacelle. While smaller ratios will tend to have lower potential for separation, flow behavior is determined by the shape between propulsors which cannot be entirely captured by one ratio. In one embodiment the ratio of outflow area to upstream flow area in some instances may be approximately 1.4 though other ranges both greater and less than this ratio are also contemplated.

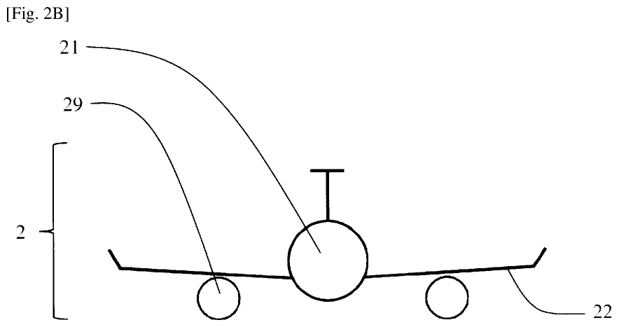

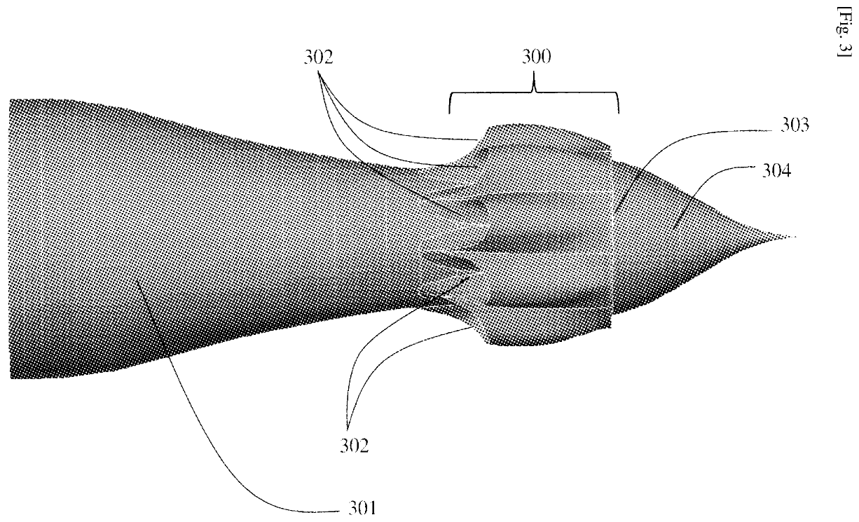

FIG. 2A shows a rear facing schematic of an aircraft 2a with BLI propulsors 200 located on and disposed around a perimeter of a fuselage 21a according to one embodiment. FIG. 2B illustrates a baseline aircraft 2 including propulsion systems 29 located under the wings 22. The BLI aircraft and baseline aircraft are similar except for details associated with propulsion and integration of the BLI propulsors. The aircraft 2a incorporating BLI propulsors may include smaller propulsion systems 29A under the wings 22A as compared to the typical underwing propulsion systems 29. This reduction in propulsion system size reflects a reduction in desired mechanical power due to the contribution of the BLI propulsors 200. Thus, the changes made to aircraft 2a may maintain similar performance to the baseline aircraft 2 but with improved efficiency resulting from the BLI propulsion system.

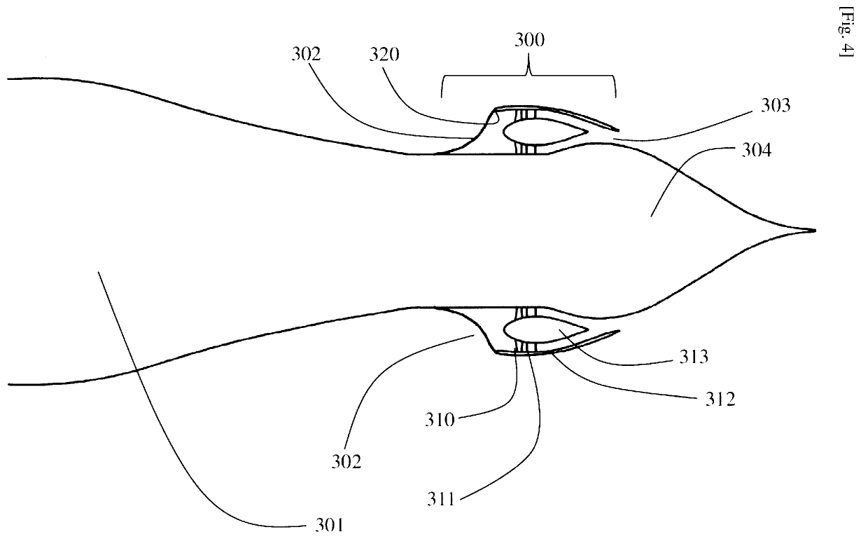

FIG. 3 shows a side view of one embodiment of a BLI propulsion system located on a tail portion of fuselage 301. A plurality of BLI propulsors 300 are shown attached to and distributed around a perimeter of a fuselage 301. The propulsors include a corresponding plurality of propulsor inlets 302 which may include a smooth transition between the propulsor inlets and the fuselage 301. The nine propulsors in this embodiment exit to a common annular nozzle 303 in a manner similar to that described above. The individual BLI propulsors may be fluidly connected upstream of the annular nozzle such that the outflows from the propulsors exit to the environment as a combined flow through the annular nozzle. Without wishing to be bound by theory, the use of the depicted annular nozzle may help to reduce flow separation associated with the separate flows from the separate propulsor outlets. Tail cone 304 or other portion of the fuselage extending downstream or rearwardly from the annular nozzle may form an inner diameter of the annular nozzle in some embodiments.

As previously noted, the BLI propulsion systems shown in the above embodiments include nine propulsors. However, other embodiments with a different number of propulsors are contemplated. For example, the number of tail-integrated propulsors may depend on the target for airframe boundary layer ingestion. Greater boundary layer ingestion by a propulsor implies more ingested mechanic al power, which is beneficial for improving the propulsive efficiency. However, this may also be associated with larger propulsor inlets, increased weight, more nacelle drag, increased higher cruise propulsive power. Therefore, it should be understood that any appropriate number of BLI propulsors may be included in an overall BLI propulsion system depending on the desired operating parameters of the aircraft.

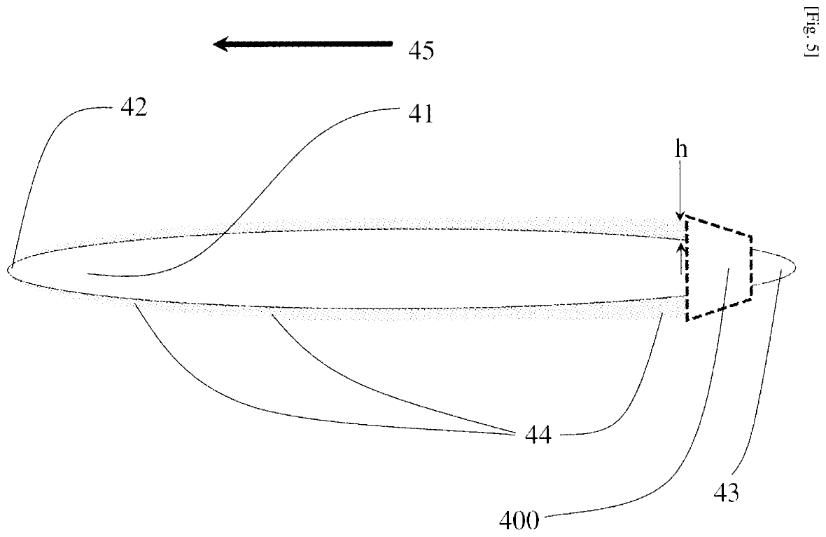

Guidelines for the determining appropriate numbers of propulsors can be observed from FIGS. 3 and 4. In some embodiments, a single propulsor may be assumed to have an approximate form of a truncated cone with a shallow taper, the inlet side being the base end of the cone such as that the flow area generally decreases from the front to the back of the propulsor (this shape holds for electric fans and gas turbines). In some embodiments it may be desirable for an inlet height to be approximately equal to the boundary layer thickness for fuselage mounted propulsors. This imparts an approximate relationship between boundary layer thickness (and therefore aircraft size and cruise conditions) and the diameter of the propulsor (for instance fan or first turbocompressor stage). As a result a maximum number of propulsors may be at least approximately deter mined by the boundary layer thickness during cruise and local fuselage diameter, or other transverse dimension perpendicular to a longitudinal axis, of the aircraft. Fuselage diameter is in turn related to the overall mission and performance of the aircraft. Hence, integrating BLI propulsors into an aircraft design may be iterative in nature. The number of propulsors and the fraction of the boundary layer captured may also be considered relative to the increased aircraft weight that could result from increasing the fraction of boundary layer ingested when deciding on a number of propulsors to use. In some instances, it may also be possible to use fewer and/or larger propulsors by at least partially insetting t hem within the fuselage.

While the embodiment shown above illustrates an axisymmetric tail, other embodiments, including the embodiment overlayed on the aircraft in FIG. 1 are envisioned with an asymmetric tail. For example, tail strike, where the tail or rear portion of the fuselage (including any propulsors) contacts the runway during takeoff, may be used to provide a geometric design limitation for the integration of BLI propulsors on a fuselage. As an asymmetric tail may allow the propulsors to be positioned higher on the aircraft (i.e., as measured when the aircraft is on the ground) an asymmetric tail may be designed with a longer fuselage than a symmetric tail while still avoiding tail strike. The use of a tapered rear portion of the fuselage extending downstream from the BLI propulsion system may also offer improvements relative to reducing flow separation downstream or rearward from the BLI propulsion system. In contrast, a shorter fuselage designed with a symmetric tail may present a more challenging design problem to prevent flow separation on the rear portion of the shorter fuselage. However, it should be understood that any of the disclosed embodiments may use either of a symmetric or an asymmetric tail portion.

FIG. 4 shows a section view of the BLI propulsion system embodiment shown in FIG. 3. Fuselage 301 includes propulsor 300 on the rear portion. Nacelle 312 may surround and form at least a portion of the plurality of propulsors. Additionally, in some embodiments, the nacelle may form the exterior portion (e.g., outer diameter) of the annular nozzle 303. The inner diameter of the exit nozzle being formed by the tail cone 304. The embodiment illustrated includes electric propulsors. The plurality of electric propulsors are connected at their outlets to the common annular nozzle and the discharge of all the BLI propulsors exits to the atmosphere around the aircraft at the annular nozzle 303. The electric propulsors may include a streamlined motor pod 313, a stator 311 and a rotor 310. Embodiments are contemplated wherein gas turbine engines are us ed replacing the electric motor components. Gas turbine engines would incorporate similar design features including the common annular nozzle.

The nacelle surrounding the propulsors 312 is shown in FIG. 4. In some embodiments, the nacelle outer contour may be configured to be similar to the prof ile of a supercritical airfoil to delay or weaken shock wave formation. Without wishing to be bound by theory, turning a flow results in a localized acceleration where the flow is turned. When the aircraft is operating at high subsonic conditions, this localized acceleration may be enough to trigger a shock wave. Shock waves are inherently lossy in nature and may result in a considerable increase in aircraft drag. A nacelle outer contour of the illustrated embodiment, or other appropriate contour for functioning as a supercritical airfoil, can turn the high-speed flow at cruise with stagnation pressure loss smaller than 1%. Likewise, curvature at the inlet lip 320 can cause streamline curvature below the inlet lip giving rise to local flow acceleration resulting in the formation of shocks and the accompanying loss of efficiency. Accordingly, reducing the curvature of the inlet lip may be effective in reducing the local overspeed thereby reducing this potential source of loss.

In view of the above, the propulsor inlets 302 may be configured to sit near the upstream end of the propulsor 300 and to capture and ingest a portion of the boundary layer that has developed around the fuselage 301. Propulsor inlets may be shaped appropriately to capture the boundary layer. In some embodiments, the inlets may be configured to be substantially free from reverse flow entering the propulsors (i.e., from separated boundary layers) and substantially free of shocks at the inlet lip. The latter is a compressible flow consideration that may occur when flow in or around the inlets approaches a Mach number of unity. Curvature of the inlet lip imparts curvature to streamlines of the flow which in turn causes local acceleration that can result in shock waves and associate d losses even when the aircraft itself is subsonic. Possible inlet shapes include round inlets and horseshoe shaped inlets although other inlet shapes are also contemplated. As elaborated on below, an upstream inlet extension may be included for a smooth transition between the fuselage and inlet to eliminate flow separation. The inlet height, measured from the fuselage to the outermost portion of the inlet, may be approximately equal to the anticipated boundary layer thickness at the location of the inlet during cruise conditions, though other heights may also be used as the disclosure is not so limited.

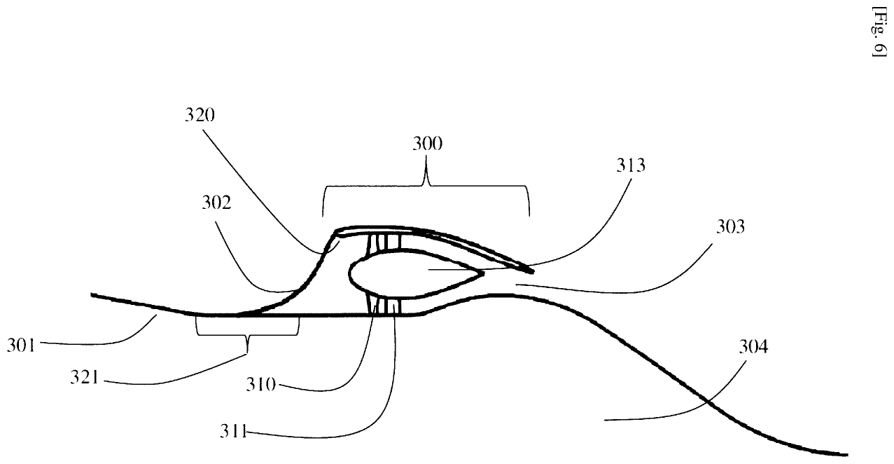

A schematic illustrating boundary layer growth over a hypothetical fuselage is illustrated in FIG. 5. Without wishing to be bound by theory, when an object such as a fuselage, moves through a fluid, such as air, a boundary layer forms around the moving object (the theory works the same way for stationary objects and moving fluids). The velocity difference between the object and far away surrounding fluid, the free stream, occurs within the boundary layer. Said another way, the boundary layer is the region in which momentum is transferred be tween the object and the free stream. As such, velocity gradients exist in the boundary layer in the direction normal to the surface of the object. In some embodiments, the thickness of the boundary layer may be defined as the thickness, or distance away from the fuselage, where 99% of the velocity difference between the object and freestream occurs. When an object moves through an otherwise motionless fluid (or a fluid moves over a motionless object or combinations thereof) the boundary layer begins to grow at the leading edge of the object and increases in thickness (measured normal to the surface of the object) moving toward the back of the object. FIG. 5. Shows a schematic of boundary layer growth. A hypothetical ellipsoidal fuselage 41 has leading end 42 and trailing end 43. The leading end 42 may be referred to as the nose or front. In the illustration the fuselage is moving to the left in the direction as indicated by arrow 45. The boundary layer 44 comprises the shaded region surrounding the ellipsoidal fuselage and becomes thicker toward the rear of the ellipsoidal fuselage. Note as well that the boundary layer thickness grows at a decreasing rate with position along the ellipsoid. The position that may be occupied by a tail mounted BLI propulsor 400 is illustrated on the schematic. The position is illustrated for location only, the trapezoid shown does not represent any particular propulsor or arrangement of propulsors and could include any embodiment disclosed herein or other embodiments. The boundary layer thickness at the inlet of the propulsor is illustrated as h in FIG. 5. Boundary layers, wakes and other flow behaviors are not illustrated in FIG. 5 downstream of the propulsor location 400 but would be present. The schematic is offered for example only to illustrate trends, and is not drawn to scale or to represent exact mathematical models of boundary layer behavior and is not intended to describe all features of a boundary layer including the differences between laminar and turbulent boundary lay ers.

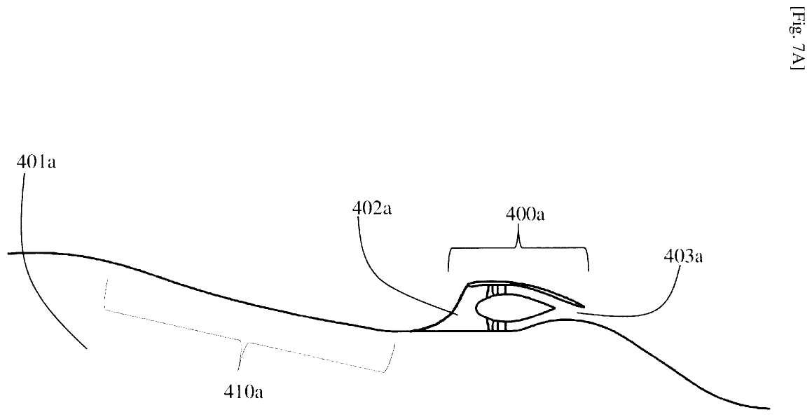

FIG. 6 is a close up view of a single propulsor from the embodiment of FIG. 4. Comparison of FIG. 6 with the embodiment detailed in FIG. 5 and the description of the boundary layer above will show that the flow into inlet 302 is by nature non-uniform for BLI propulsors. By design boundary layer flow is non-uniform as the flow nearer a body (i.e. fuselage) has a velocity nearer to that of the body and flow farther from the body has a velocity closer to that of the freestream. In the limits at the outer edge of the boundary layer the velocity is approximately equal to the freestream velocity (99%) and at the surface of the body the relative velocity between the fluid and body is approximately zero. Non-uniform velocity means spatial non-uniformity, nothing should be assumed about the steadiness or time variation of such flow. The boundary layer enters inlet 302 with a velocity profile that varies from zero velocity at the surface of fuselage 301 to nearly freestream velocity, or other appropriate velocity depending on the size of the boundary layer and, at the inlet lip 320 (this may also be seen in FIG. 10 corresponding to the example below). Non-uniform velocity distribution at the inlet may present a challenge for the design of BLI propulsion systems and the turbomachinery used in the propulsors. To address t his problem, the fan selected for a BLI installation may advantageously have a low efficiency penalty for rotor inflow at an incidence away from the nominal design point of the fan. Said another way, a fan may be selected to be tolerant of variations in the velocity and direction of the incoming flow since such variations will be present in the ingested boundary layer.

In some embodiments, a target fraction of boundary layer ingested into a BLI propulsion system during normal operation may be greater than or equal to ap proximately 70% though any appropriate ingestion percentage may be used depending on the particular design. With this amount of ingestion, the flow at the propulsor inlet may be non-uniform, both radially and circumferentially. Further, the inlet distortion may cause incidence angle variations at the rotor leading edge plane, resulting in a penalty on isentropic efficiency of the fan. The isentropic efficiency drop may be between or equal to 1.5% and 6%, 1.5% and 8%, 1.5% and 10%, and/or other ranges depending on the fan design and the inlet distortion. As, the BLI benefit in fuel consumption may be sensitive to changes in the fan efficiency, it may be desirable to provide a fan configured to provide a low efficiency penalty for incidence swings due to inlet distortion. For example, the efficiency isentropic efficiency drop may be less than or equal to 5%.

One potential way to reduce the rotor inlet incidence variation due to BLI is through the upstream influence of non-axisymmetric stators. Without wishing to be bound by theory, for 2D flow stator exit flow angle perturbations 180 degrees out of phase with the rotor inlet incidence variation, non-uniform static pressure perturbations that are about 90 degrees out of phase with the rotor incidence variation may be effective in modifying the flow at the rotor inlet. For 3D flow, an optimized out-of-phase angle may depend on the specific boundary layer profile and fan operating conditions. Further, since the static pressure perturbation is not felt upstream in supersonic flow, the effectiveness of non-axisymmetric stators may also depend on the relative flow Mach number. As elaborated on further below in the examples, the effectiveness of non-axisymmetric stators may be limited if the rotor relative flow is mostly supersonic.

Because the stagnation pressure of the boundary layer is lower than freestream a higher pressure ratio and a higher fan rotational speed may be desired for a tail mounted BLI fan than for a similar fan in uniform flow, to produce the desired propulsive power. In this aspect, BLI benefit is a trade-off between propulsive efficiency increase due to ingested mechanical power, and fan shaft power consumption increase due to fan efficiency decrease and higher rotational speed.

As noted above, it is desirable in some applications to avoid flow separation from the fuselage when using BLI propulsors on an aircraft. However, tail-integrated propulsors may affect boundary-layer evolution on the rear portion of the airframe because of upstream static pressure influence. This may lead to flow separation if not properly designed. Specifically, the transition section between the constant-radius fuselage and the rear portion, where the BLI propulsors are mounted, may be designed to minimize adverse pressure gradients upstream of the propulsors. A smooth transition between the tail and the propulsor may be desirable to reduce the incidence, and potentially avoid, the creation of reverse flow due to an abrupt transition, which can increase losses and cause a penalty on the overall propulsive efficiency. This region is illustrated as region 321 in FIG. 6 that transitions smoothly into the inlet(s) 302 of the associated BLI propulsors 300.

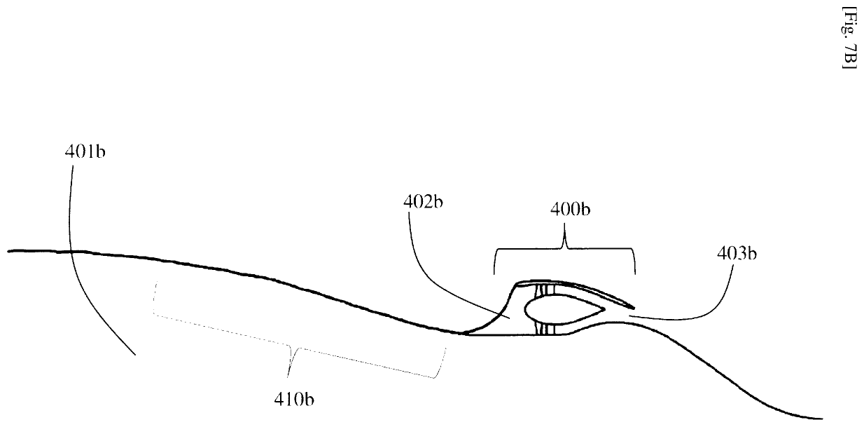

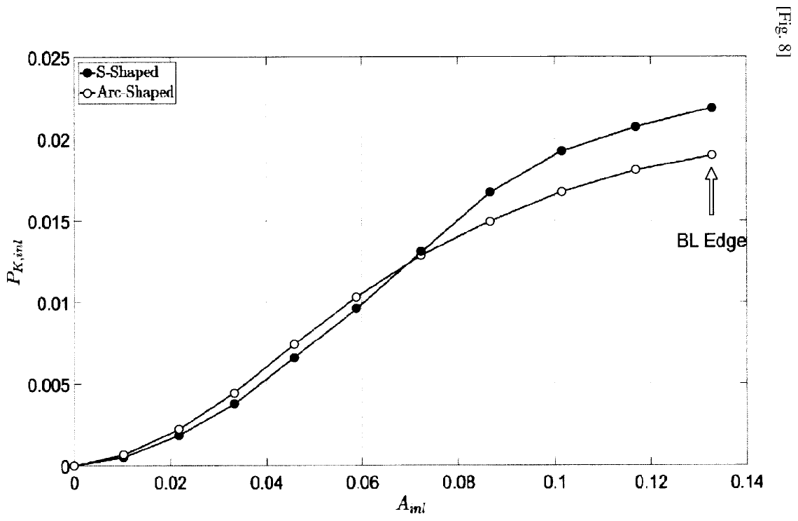

FIG. 7A. illustrates an embodiment of a rear fuselage taper with an S-shaped curve. In such an embodiment, a fuselage 401a may neck down from a first larger transvers dimension to a second smaller transverse dimension along an S-shaped curve upstream of the propulsors 400a. FIG. 7B. illustrates an embodiment of a rear fuselage with an arc shaped curve. In another embodiment, fuselage 401b may neck down from a first larger transvers dimension to a second smaller transverse dimension along an arc shaped curve upstream of the propulsors 400b. Either illustrated fuselage taper may be effective at mitigating separation on the rear or tail portion of the fuselage. However, the two fuselage profiles illustrated are not the only possible profiles, and other shapes including asymmetric profiles are contemplated as the disclosure is not limited in this fashion.

### Example: BLI Propulsion System Design

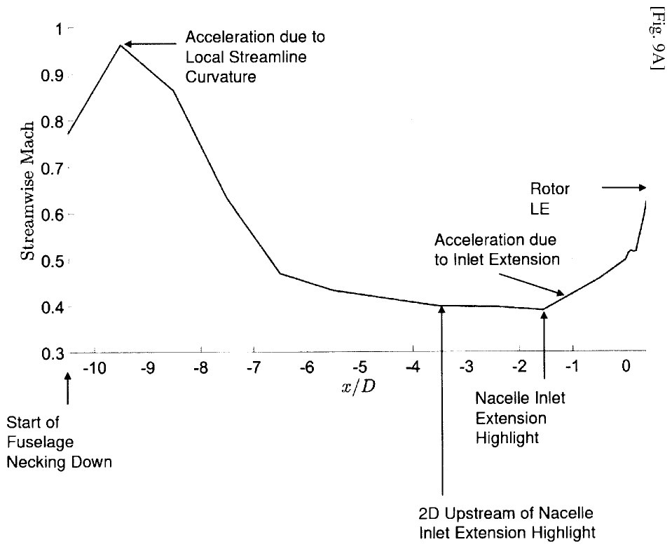

BLI propulsion system designs similar to those illustrated in the figures and d escribed herein were studied. For the following examples, the S-shaped tail was chosen rather than an arc-shaped tail due to the larger ingested mechanical power. FIGS. 7A and 7B illustrate the two types of tail profiles and FIG. 8 shows the mechanical power ingested P_{K,inl} for the profiles illustrated. Similarly, entropy generation Δ_{s_inl} ingested by the propulsor was higher for the S shaped curve for the inlet areas corresponding to an inlet height approximately equal to the boundary layer thickness.

### Example: BLI Propulsion Systems Including Precompression

The shape of the rear portion of the fuselage was configured to allow for pre compression of air upstream of the propulsor inlets which has been found desirable for propulsor performance using the various embodiments described herein. For example, in some embodiments, it may be beneficial to provide an average Mach number of at least 0.4 in fluid two inlet diameters upstream from and adjacent to the propulsor inlet extension highlight during cruise of the aircraft. The inlet extension is seen as the ramp-like structure immediately upstream of the inlet and serving as a fairing to smooth transition between the fuselage and the propulsor inlet. In some embodiments the boundary layer edge streamline coming from the end of constant radius fuselage enters the propulsor inlet at the top, consistent with an inlet height equal to boundary layer thickness and with the local edge Mach number approximately 0.7. The propulsors thus ingest a bout 70% of the boundary layer. For aircraft other than transportation aircraft operating with a cruise Mach number in the range 0.7-0.85 these values may be adjusted according to the designed cruise conditions of such aircraft, including aircraft that cruise below Mach 0.7.

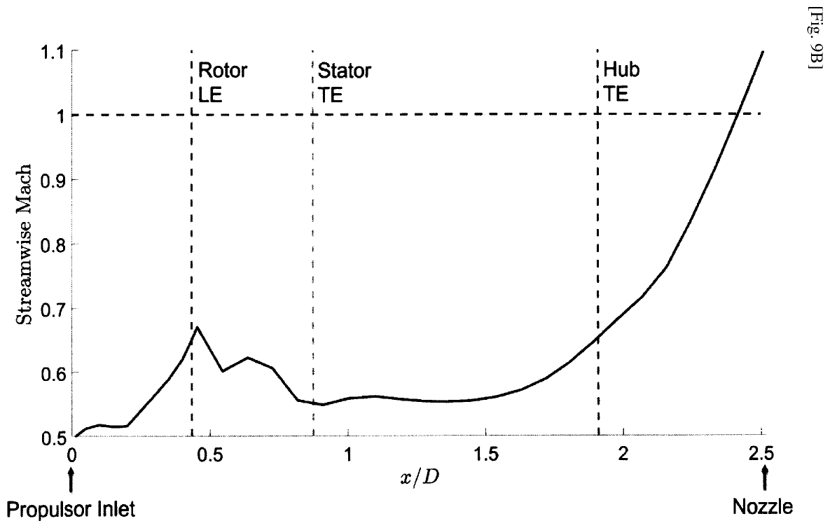

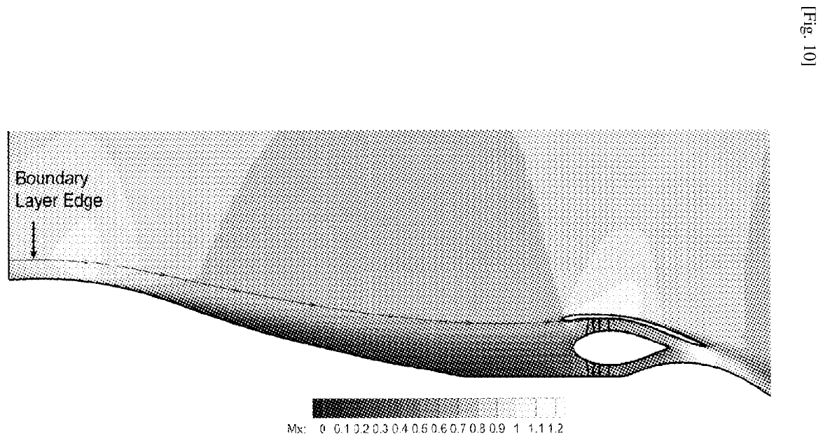

A plot of Mach number vs position along the fuselage and upstream of the propulsor inlet is depicted in FIG. 9A. The propulsor inlet is located at x/D=0, where x is a distance along the fuselage in a longitudinal direction and D is a propulsor inlet diameter. Negative x/D values indicate the location is upstream of the propulsor inlet. Location x/D=−2 therefore represents 2 inlet diameters upstream of the propulsor inlet. As noted on the figure, the inlet extension highlight is located around x/D=−1.6 so the precompression Mach number should be evaluated 2 diameters upstream or at x/D=−3.6 as illustrated in the figure. The Mach number at the location 2 inlet diameters upstream is seen to be approximately Mach 0.4.

A plot of Mach number vs position within the propulsor is illustrated in FIG. 9B. Distance along the propulsor is non-dimensionalized as x/D, where D is a propulsor inlet diameter as in FIG. 9A. FIG. 9B depicts an electric propulsor including a fan (or rotor) and a stator consistent with the embodiment illustrated in previous figures including FIGS. 3, 4 and 6. LE and TE denote leading and trailing edge respectively. The propulsor inlet corresponds to inlets 302 and the nozzle to annular nozzle 303, both illustrated in FIGS. 3 and 4. As can be seen in the graph, the velocity through the propulsor generally increases in the direction of the trailing edge of the propulsor, the only region not following this trend being within the turbomachinery section including the fan and stator. FIG. 9B is a continuation of FIG. 9A, overlapping at the origin along the x-axis.

### Example: BLI Propulsion Systems Performance Analysis

For a performance analysis, a theoretical BLI propulsor design was developed and analyzed for installation on a baseline aircraft. The baseline aircraft represents an unmodified B737-800 with low fan pressure ratio (FPR) turbofans. The tail BLI aircraft was adapted from the baseline aircraft with a circumferential array of BLI propulsors mounted on the rear tail as in FIGS. 1A, 1B, 3, 4. To a void tail strike, the tail profile and the location of tail BLI propulsors were designed to fit the integrated propulsors within the existing non-axisymmetric fuselage outline. Operating conditions for the analysis were selected to be a cruise Mach number of 0.8 and an altitude of 35,100 ft. The performance characteristics of the baseline aircraft are shown below in Table 1. Table 1 is a table of characteristics of a baseline example aircraft.

TABLE 1

| Input Parameters (Turbofans) | | Output Parameters (Single Fan) | | |
|---|---|---|---|---|
| Fan Pressure Ratio | 1.35 | Fan Diameter | 86 | in |
| Fan Face Mach | 0.618 | Fan Mass Flow | 235 | kg/s |
| Isentropic Efficiency | 0.930 | Propulsive Power | 4972 | kW |
| Fan LE HTR | 0.375 | Shaft Power | 6063 | kW |
| Inlet Pressure Recovery | 0.9995 | Propulsive Efficiency | 0.820 | |
| Nozzle Discharge Coefficient | 0.9863 | TSFC [lbf/lbm-hr] | 0.513 | |
| Bypass Ratio | 12.5 | | | |
| Propulsor Wetted Area/Fan Area | 16.0 | | | |
| Flight Mach Number | 0.80 | | | |

The adopted design had an axisymmetric tail with nine identical tail BLI propulsors attached to a distributed around a tail portion of the aircraft (see FIGS. 1B, 1C and 3). This was done for two main reasons. First, using the axisymmetric tail enabled the partitioning of the computation domain into Nₚᵣₒₚ identical computational sub-domains, with Nₚᵣₒₚ being the number of tail-integrated propulsors. Computational Fluid Dynamics (CFD) simulations could thus be executed in one sub-domain, shortening the turnaround time to speed up the design exploration. Second, and more important, designing tail BLI propulsors with an axisymmetric tail does not lower the level of difficulty for design. The tail transition may need to be shorter than a non-axisymmetric tail to avoid tail strike and fit in the existing fuselage outline, as described previously. Additionally, a shorter tail may be more likely to result in flow separation upstream of the tail BLI propulsor inlet. Hence, a BLI propulsor design for the axisymmetric tail that meets performance goals should be appropriate for a non-axisymmetric tail as well.

For the BLI modification of the baseline aircraft, the number of integrated propulsors was chosen to be nine to make the propulsor inlet diameter approximately the same as the local boundary layer thickness as previously described in this disclosure. FIG. 1C is an isometric view of the BLI propulsors on the axisymmetric tail (parts of eight of the nine propulsors can be seen). FIG. 10 shows contours of the axial Mach number at propulsor centerline and the boundary layer edge streamline. For clarity of the Mach number contours, components are not labeled in FIG. 10 but would be identical to those in FIGS. 6 and 7A. It can be seen that the boundary layer edge streamline coming from the end of constant-radius fuselage enters the propulsor inlet at the top, with the local edge Mach number approximately 0.7. The propulsors thus ingest about 70% of the boundary layer. It is noted that this configuration may not be optimal and a sensitivity study of tail BLI benefit versus number of integrated propulsors for a particular design may be implemented as well though the general observed trends are expected to be applicable to other propulsor configurations as well.

FIG. 10 further illustrates a fluid streamline which may refer to a curve that is tangent to the velocity vectors of a flow field everywhere along its length. The streamline illustrated in FIG. 10 is labeled “Boundary Layer Edge” in the figure. It will be observed that the streamline illustrated as the boundary layer edge is tangent to the surface of the propulsor inlet (see also 320 FIG. 6), exemplifying the propulsor inlet height being equal to the boundary later thickness as described elsewhere in this disclosure.

Table 2 below shows the performance characteristics of the underwing propulsion system of the theoretical modified aircraft with BLI propulsors. The propulsion system characteristics shown in Table 2 correspond to smaller underwing propulsors than the baseline aircraft, as schematically shown in comparison of FIGS. 2A and 2B, the table being of that represented by the smaller propulsion system 29a in FIG. 2A of the aircraft including BLI propulsors. The BLI performance characteristics of electric propulsors of the modified aircraft are shown in Table 3. The modified aircraft would therefore have underwing propulsion systems of Table 2 and nine propulsors of Table 3, consistent with the configuration shown in FIG. 2A. Table 2 is a table of underwing engine characteristics of an example aircraft with one embodiment of BLI. Table 3 is a table of BLI propulsor characteristics of an example aircraft with the embodiment of BLI of FIG. 7A.

TABLE 2

| Input Parameters (Turbofans) | | Output Parameters (Single Fan) | | |
|---|---|---|---|---|
| Fan Pressure Ratio | 1.35 | Fan Diameter | 64 | in |
| Fan Face Mach | 0.618 | Fan Mass Flow | 123 | kg/s |
| Isentropic Efficiency | 0.930 | Propulsive Power | 2838 | kW |
| Fan LE HTR | 0.375 | Shaft Power | 3347 | kW |
| Inlet Pressure Recovery | 0.9995 | Propulsive Efficiency | 0.848 | |
| Nozzle Discharge Coefficient | 0.986 | TSFC [lbf/lbm-hr] | 0.514 | |
| Bypass Ratio | 12.5 | | | |
| Propulsor Wetted Area/Fan Area | 16.0 | | | |
| Flight Mach Number | 0.80 | | | |

TABLE 3

| Input Parameters (Electric Fans) | | Output Parameter (Single Fan) | | |
|---|---|---|---|---|
| Fan Pressure Ratio | 1.50 | Fan Diameter | 24 | in |
| Fan Face Mach | 0.60 | Fan Mass Flow | 16 | kg/s |
| Isentropic Efficiency | 0.878 | Propulsive Power | 517 | kW |
| Fan LE HTR | 0.375 | Shaft Power | 560 | kW |
| Inlet Pressure Recovery | 0.995 | Propulsive Efficiency | 0.876 | |
| Nozzle Discharge Coefficient | 0.957 | | | |
| Bypass Ratio | 12.5 | | | |
| Propulsor Wetted Area/Fan Area | 10.33 | | | |
| Nacelle Inlet Relative to Tail Tip | 16.8 ft | | | |
| Flight Mach Number | 0.80 | | | |
| P_{K. int} vs. Area | Curve Fit | | | |
| Δsᵢₙₜ vs. Area | Curve Fit | | | |

The metric for the overall aircraft performance may be selected as the Propulsion Fuel Energy Intensity (PFEI), because it is directly proportional to the fuel consumption for the entire mission. At cruise, the PFEI for the tail BLI aircraft was 10.4% lower than the baseline aircraft. The largest contribution to the improvement in PFEI was the reduction of airframe surface dissipation by 9.7% for the tail BLI aircraft than the baseline. That corresponds to the reduction of total net propulsive power by the same percentage, 9.7%, for the tail BLI aircraft than the baseline. Further, the tail BLI aircraft had propulsive efficiency 5.6% higher than the baseline. The combined effects of reduced airframe surface dissipation and improved propulsive efficiency for the tail BLI aircraft result in a PFEI benefit of 10.4%. Table 4 shows the breakdown of engine propulsive power Pₚₘₒₚ, shaft power P_{shaft} and propulsive efficiency ηₚ for the baseline and tail BLI aircraft configurations, respectively. The turbofans on tail BLI aircraft had a higher propulsive efficiency than those on the baseline aircraft, because the jet velocity was lower for the former. The consumed shaft power for the tail BLI aircraft was 3.2% lower than the baseline. Shaft power, however, may be a quantity that is minimized during fan design, and it can be computed directly in CFD. Table 4 is a table of performance predictions for a baseline aircraft compared to an aircraft with the BLI embodiment of FIGS. 3, 4 and 7A and Tables 2-3.

TABLE 4

| Baseline Aircraft | | Tail BLI Aircraft | |
|---|---|---|---|
| Turbofan Total Pₚᵣₒₚ [kW] | 10826 | Turbofan Total Pₚᵣₒₚ [kW] | 5682 |
| Turbofan Total P_{shaft} [kW] | 12127 | Turbofan Total P_{shaft} [kW] | 6695 |
| Turbofan ηₚ | 0.820 | Turbofan ηₚ | 0.848 |
| | | Electric Fan Total Pₚᵣₒₚ [kW] | 4094 |
| | | Electric Fan Total P_{shaft} [kW] | 5042 |
| | | Electric Fan ηₚ | 0.923 |
| Overall ηₚ | 0.820 | Overall ηₚ | 0.876 |
| Total Prop. System Weight [lb] | 22537 | Total Prop. System Weight [lb] | 21257 |
| Operating Empty Weight [lb] | 97289 | Operating Empty Weight [lb] | 95897 |
| PFEI [kJ/(kg · km)] | 6.60 | PFEI [kJ/(kg · km)] | 5.91 |

Without wishing to be bound by theory, the reduction in shaft power has an exponential impact on the decrease in PFEI, which is explained Math. 1 as follows. PFEI is defined in terms of payload W_{pay}, fuel weight W_{fuel}, specific heating value h_{fuel}, and total range Rₜₒₜₐₗ:

$$PFEI = \frac{{W}_{{fuel}^{}} {h}_{f u e l}}{{gW}_{pay} {R}_{t o t a l}} . \qquad [ Math . 1 ]$$

The quantities W_{pay}, and Rₜₒₜₐₗ are constant for the present analyses, and g is the gravitational constant. The rate of fuel consumption Math. 2 can be related to the shaft power via the specific heating value h_{fuel}, thermal efficiency ηₜₕ (defined as the ratio of kinetic energy change rate to fuel chemical energy consumption rate) and transfer efficiency ηₜᵣ (defined as the ratio of shaft power to kinetic energy change rate):

$${\dot{m}}_{fuel} = \frac{{P}_{shaft}}{{h}_{fuel} {η}_{t h} {η}_{tr}} . \qquad [ Math . 2 ]$$

Based on the Breguet equation, the weight ratio W_{C2}/W_{C1} with range R_{cruise} can be written as Math. 3:

$$\frac{{W}_{C 2}}{{W}_{C 1}} = exp [ - ( \frac{g}{W} \frac{1}{V} \frac{{P}_{shaft}}{{h}_{fuel} {η}_{t h} {η}_{tr}} ) {R}_{cruise} ] . \qquad [ Math . 3 ]$$

The quantity V is the cruise velocity. The cruise fuel burn W_{fuel}^{cruise} is given by Math. 4:

$${W}_{fuel}^{cruise} = {W}_{C 1} - {W}_{C 2} . \qquad [ Math . 4 ]$$

Reducing the shaft power P_{shaft} decreases the fuel burn during cruise exponentially. Cruise may account for 86% of fuel used in the mission, so the total fuel consumption W_{fuel} and thus PFEI also decrease exponentially with respect to the reduction in shaft power at cruise.

The BLI benefit in terms of PFEI is defined as Math. 5:

$$BLI Benefit = \frac{{PFEI}_{baseline} - {PFEI}_{T ailBLI}}{{PFEI}_{b a s e l i n e}} . \qquad [ Math . 5 ]$$

The PFEI benefit for tail BLI aircraft with an installed electric fan efficiency η_{fan}=0.878, is 10.4% compared with the baseline. The sensitivity to the install ed electric fan efficiency, can be found by varying the tail BLI electric fan efficiency while holding the underwing turbofan efficiency constant. It has been found that a 1% increase in tail BLI electric fan efficiency produces a BLI benefit increase of approximately 0.8%.

While some embodiments described in this disclosure, including the example above are directed to manned transportation aircraft, this disclosure is not to be limited to such aircraft. It has been recognized that aspects described herein may be applied to unmanned aircraft including those described as drones. Aircraft incorporating BLI propulsion may be larger or smaller than the embodiments shown and those aircraft may operate at altitudes and airspeeds different from those listed for transportation aircraft. BLI propulsion may be applied to aircraft with or without other propulsion sources. BLI propulsion may therefore be the only source of propulsion in some embodiments. One example of another propulsion source being the underwing propulsion systems of the example and FIG. 2A. The BLI propulsors may be any type of propulsor capable of ingesting a boundary layer. Other propulsion systems, including underwing installations, may be fans driven by electric motors, gas turbine engines, piston engines, or any other suitable motors. Aircraft incorporating the embodiments described herein may be all electric, all gas turbine, or any combination thereof, such aircraft may additionally include any type of BLI propulsor combined with other non-BLI propulsors that are not air breathing.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which m ay include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limit ed to such embodiments or examples. On the contrary, the present teachings encompass various alternatives, modifications, and equivalents, as will be appreciated by those of skill in the art. Accordingly, the foregoing description and drawings are by way of example only.

1. An aircraft comprising:
a fuselage;
a plurality of propulsors disposed on and distributed around at least a portion of a perimeter of the fuselage, the plurality of propulsors configured to ingest at least a portion of a boundary layer from the fuselage during operation of the aircraft; and
a common annular exit nozzle fluidly coupled to a plurality of propulsor outlets of the plurality of propulsors, wherein an outflow from the plurality of propulsors flows through the common annular exit nozzle during operation of the aircraft.

2. The aircraft according to claim 1, further comprising a plurality of propulsor inlets in fluid communication with the plurality of propulsors, wherein the plurality of propulsor inlets are configured to ingest at least a portion of a boundary layer from the fuselage.

3. The aircraft according to claim 2, wherein the plurality of propulsor inlets are configured to have a height equal to about a thickness of the boundary layer from the fuselage at a location adjacent to and upstream of the plurality of propulsor inlets.

4. The aircraft according to claim 1, wherein the fuselage includes a tapered rear portion extending downstream from the plurality of propulsors.

5. The aircraft according to claim 1, wherein the aircraft includes one or more propulsors configured to ingest air from outside the boundary layer.

6. The aircraft according to claim 1, wherein the plurality of propulsors are driven by electrical motors and/or gas turbine engines.

7. The aircraft according to claim 1, further comprising a nacelle at least partially containing the plurality of propulsors.

8. The aircraft according to claim 7, wherein the nacelle is configured to operate as a supercritical airfoil.

9. The aircraft according to claim 1, wherein the plurality of propulsors are configured to ingest at least 50% of the boundary layer at a cruise condition.

10. The aircraft according to claim 1, wherein the cruise condition includes operation of the aircraft at an altitude between 20,000-51,000 ft and a Mach number between 0.7-0.85.

11. An aircraft comprising:
a fuselage;
a propulsor disposed on the fuselage, wherein the propulsor includes a propulsor inlet, wherein the propulsor inlet is configured to ingest at least a portion of a boundary layer from the fuselage, and wherein a portion of the fuselage upstream from the inlet is configured to provide an average Mach number of at least 0.4 in fluid two inlet diameters upstream from and adjacent to the propulsor inlet extension highlight during cruise of the aircraft.

12. The aircraft according to claim 11, wherein the propulsor inlet has a transverse dimension equal to a thickness of the boundary layer during a cruise condition, the boundary layer existing on the fuselage and its thickness measured at a location upstream and adjacent to the propulsor inlet.

13. The aircraft according to claim 11, wherein the propulsor is a plurality of propulsors disposed on the fuselage, and wherein the plurality of propulsors are disposed on and distributed around a perimeter of the fuselage, and wherein the plurality of propulsors are configured to ingest at least a portion of a boundary layer from the fuselage.

14. The aircraft according to claim 13, wherein the plurality of propulsors are fluidly connected to a single annular exit nozzle such that the plurality of propulsors arranged to outflow through the annular exit nozzle during operation of the aircraft.

15. The aircraft according to claim 13, further comprising a nacelle at least partially containing the plurality of propulsors.

16. The aircraft according to claim 15, wherein the nacelle is configured to operate as a supercritical airfoil.

17. The aircraft according to claim 11, wherein the fuselage includes a tail portion, and wherein the propulsor is disposed on the tail portion of the fuselage.

18. A method for operating a boundary layer ingesting aircraft propulsion system, the method comprising:
ingesting at least a portion of a boundary layer attached to a fuselage of an aircraft into a plurality of propulsors; and
flowing an outflow from the plurality of propulsors through a common annular exit nozzle.

19. The method according to claim 18, wherein ingesting a portion of the boundary layer comprises ingesting at least 50% of the boundary layer.

20. The method according to claim 18, further comprising operating the aircraft at an altitude between 20,000-51,000 ft and a Mach number between 0.7-0.85 during ingestion of at least 50% of the boundary layer.
